(19) United States
(12) Patent Application Publication
(10) Pub. No.: US 2012/0162967 A1
(43) Pub. Date: Jun. 28, 2012

(54) VIDEO DISPLAY DEVICE AND BACKLIGHT UNIT

(76) Inventor: Kazushige Ida, Fukaya-shi (JP)

(21) Appl. No.: 13/308,425

(22) Filed: Nov. 30, 2011

(30) Foreign Application Priority Data
Dec. 24, 2010 (JP) 2010-288779

(51) Int. Cl. G09F 13/04

(52) U.S. Cl. 362/97.1

(57) ABSTRACT

According to one embodiment, a video display device includes a housing, a display module, a light guide, and a component. The housing houses at least part of the display module. The light guide is located opposite the display screen of the display module with respect to the display module. The component includes a flexible printed circuit board, light emitters, and a terminal. The flexible printed circuit board is arranged along an edge of the light guide. The light emitters face the edge of the light guide on the flexible printed circuit board. The terminal is electrically connected to the light emitters on the flexible printed circuit board. The flexible printed circuit board includes a base portion and a protruding portion. The base portion is provided with the light emitters. The protruding portion extends from the base portion along a direction crossing the base portion and includes the terminal.

### CROSS-REFERENCE TO RELATED APPLICATIONS

This application is based upon and claims the benefit of priority from Japanese Patent Application No. 2010-288779, filed Dec. 24, 2010, the entire contents of which are incorporated herein by reference.

### FIELD

Embodiments described herein relate generally to a video display device and a backlight unit.

### BACKGROUND

There have been known video display devices provided with a light guide plate and a plurality of light emitting diodes (LEDs) as a backlight. The light guide plate is located behind the display module, while the LEDs are located on a flexible printed circuit board to face the side edge of the light guide plate.

In this type of video display device, there may be provided a terminal on the flexible printed circuit board to supply power to the LEDs. In this case, depending on the location of the terminal, for example, a connector having the terminal or a connector connected to the terminal may affect the layout of other components or increase the size of the video display device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a video display device according to an embodiment;

FIG. 2 is an exemplary side view of the video display device in the embodiment;

FIG. 3 is an exemplary back view of the video display device without a back cover in the embodiment;

FIG. 4 is an exemplary side view (partly including a cross sectional view) of a portion of the main body of the video display device in the embodiment;

FIG. 5 is an exemplary schematic back view illustrating the arrangement of a light guide and a plurality of components of the video display device in the embodiment;

FIG. 6 is an exemplary perspective view of a component of the video display device before assembly in the embodiment;

FIG. 7 an exemplary perspective view of the component illustrated in FIG. 6 and a flat cable connected to the components after assembly in the embodiment; and

FIG. 8 is an exemplary side view (partly including a cross sectional view) of a portion of the main body of a video display device according to a modification of the embodiment.

### DETAILED DESCRIPTION

In general, according to one embodiment, a video display device comprises a housing, a display module, a light guide, and a component. The display module comprises a display screen and is configured to be at least partly housed in the housing. The light guide is located opposite the display screen with respect to the display module. The component comprises a flexible printed circuit board, light emitters, and a terminal. The flexible printed circuit board is arranged along an edge of the light guide. The light emitters are arranged on the flexible printed circuit board along the edge of the light guide to face the edge. The terminal is provided to the flexible printed circuit board and configured to be electrically connected to the light emitters. The flexible printed circuit board comprises a base portion and a protruding portion. The base portion is provided with the light emitters arranged to face the edge. The protruding portion extends from the base portion along a direction crossing the base portion toward an opposite side of the display module. The protruding portion comprises the terminal.

Exemplary embodiments will be described in detail below with reference to the accompanying drawings, in which, for the sake of convenience, directions are defined as follows: X direction indicates the left direction in the front view of the display screen (the right direction in the back view); Y direction indicates the up direction; and Z direction indicates the normal direction of the display screen.

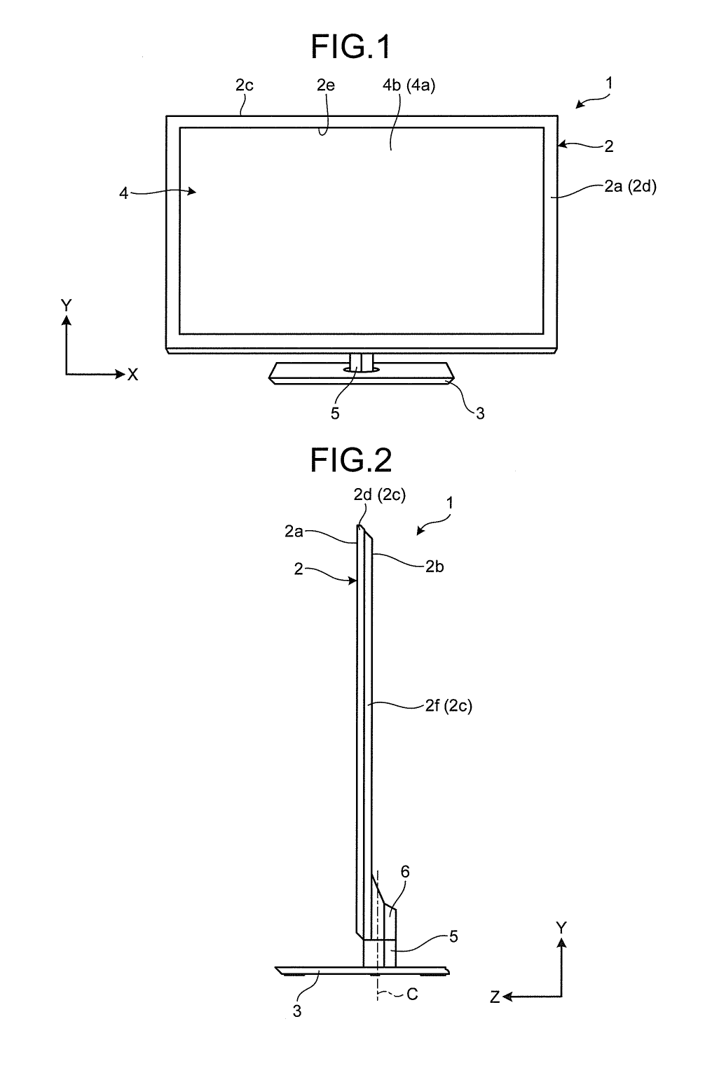

As illustrated in FIGS. 1 and 2, a video display device 1 of an embodiment will be described by way of example as a television receiver. The video display device 1 comprises a base 3 and a relatively thin flat rectangular main body 2. The main body 2 is supported on the base 3 via a leg 5 and an attachment portion 6. The main body 2 comprises a housing 2c on a front surface 2a of which is provided a rectangular opening 2e. The housing 2c houses therein a display module 4 (a display unit 8) having a display screen 4a that is exposed from the opening 2e. The display module 4 may be, for example, a liquid crystal display (LCD) panel or an organic electroluminescent display (OELD) panel.

For example, the housing 2c is formed of a combination of parts such as a front mask 2d on the front surface 2a side and a back cover 2f on the side of a back surface 2b. The attachment portion 6 protrudes from the back surface 2b toward the back, and is supported by the leg 5 to be rotatable about the rotation axis C.

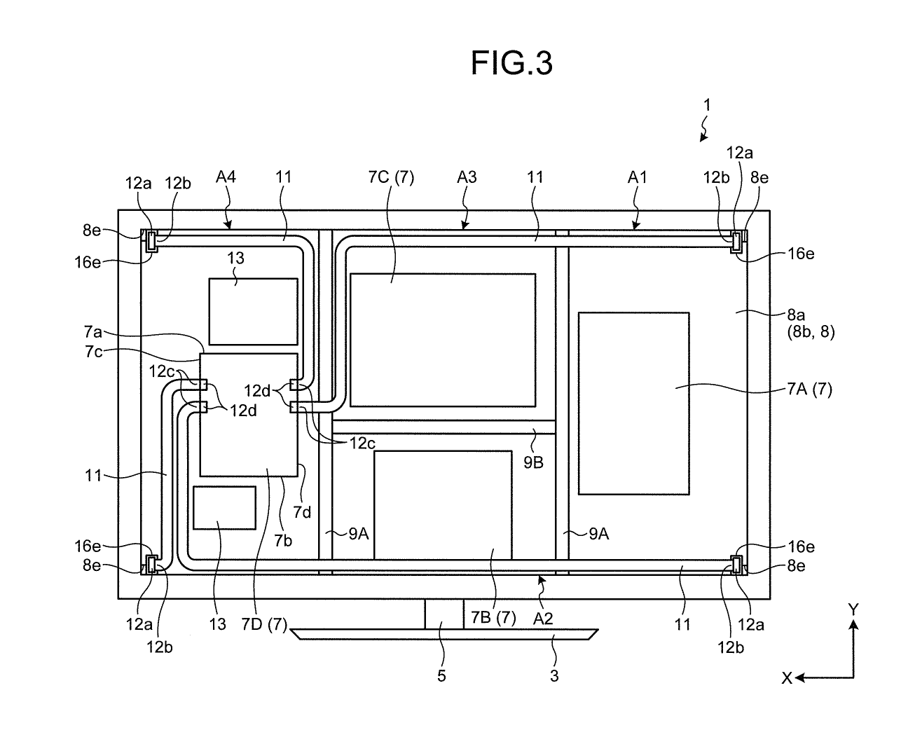

As illustrated in FIG. 3, a plurality of circuit boards 7 (7A to 7D) are attached by fasteners such as screws (not illustrated) onto a back surface 8a of the display unit 8 including the display module 4. The circuit boards 7 are each fixed on a boss (not illustrated) protruding on the back surface 8a. Thus, there is a space between the circuit boards 7 and the back surface 8a.

The back surface 8a of the display unit 8 corresponds to a back cover 8b that is provided with two frames 9A and a frame 9B. The frames 9A are spaced apart in the horizontal direction and extend in the vertical direction. The frame 9B is a bridge between the vertical centers of the frames 9A and extends in the horizontal direction. The frames 9A and 9B protrude toward the opposite of the display screen 4a, i.e., on the back surface 8a. The frames 9A and 9B are portions (reinforcement portions, frame portions) that structurally reinforce the display unit 8. The frames 9A and 9B may be formed by partly bending the back cover 8b by pressing or the like, or by adding other parts. The frames 9A and 9B may also be formed by partly bending the back cover 8b and then adding other parts.

In the example of FIG. 3, the frames 9A and 9B are connected in an H-shape. The frames 9A and 9B divide the back surface 8a of the display unit 8 into areas A1 to A4. In the back view (i.e., in the view of FIG. 3), the area A1 is located on the right side of the right frame 9A, the areas A2 and A3 are located below and above the frame 9B, respectively, in the horizontal center, and the area A4 is located on the left side of the left frame 9A. In FIG. 3, the circuit boards 7A to 7D are installed in the areas A1 to A4, respectively.

The circuit board 7A in the right area A1 is provide with, for example, a tuner, a connector for external connection, and the like (all not illustrated). The circuit of the circuit board 7A processes a signal received via the tuner, the connector, or the like, and outputs video data, audio data and the like.

The circuit board 7B in the lower horizontal center area A2 is provided with a frame rate control (FRC) circuit, a timing control (TCON) circuit, and the like. In the circuit board 7B, the FRC circuit is arranged above the TCON circuit. Although not illustrated, a gate drive circuit that drives the display module 4 is provided at a position along the lower edge of the display module 4 below the circuit board 7B.

The circuit board 7C in the upper horizontal center area A3 is provided with a power source circuit and the like. The arrangement of the power source circuit in the horizontal center area achieves a shorter power supply cable (not illustrated) that is routed between the circuit board 7C and the circuit boards 7A, 7B, and 7D. Further, the arrangement of the circuit board 7C on the upper side allows heat generated by the power source circuit to be discharged upward easier compared to the case where the circuit board 7C is arranged on the lower side. This facilitates to control the influence of the heat on other parts (for example, the circuit boards 7A, 7B, and 7D).

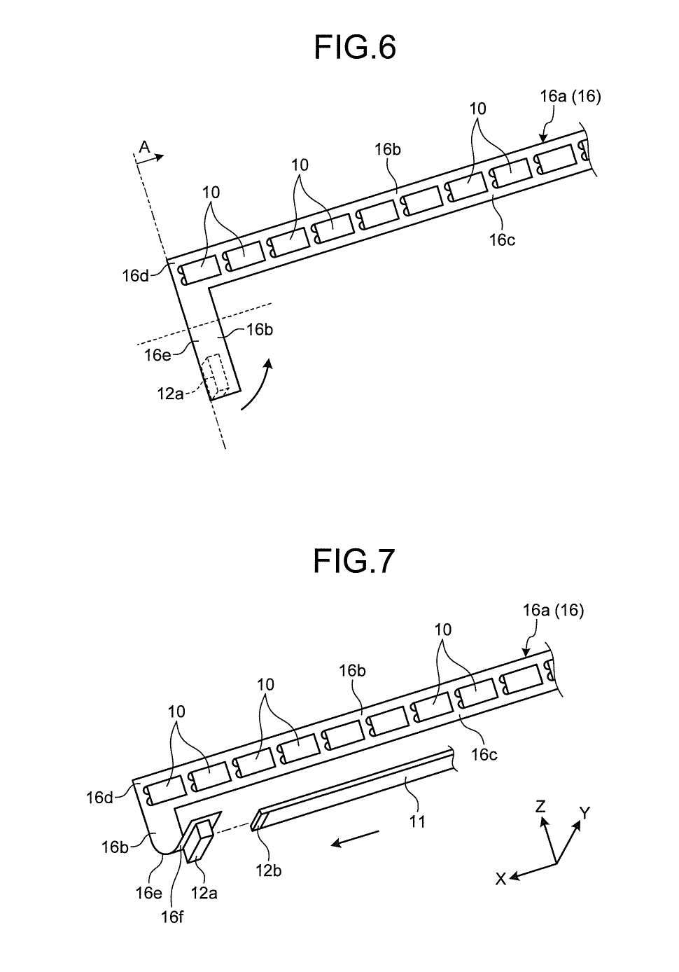

The circuit board 7D in the left area A4 is provide with a drive circuit that controls the light emission of a plurality of light emitters 10 such as, for example, light emitting diodes (LEDs) and the like (see FIGS. 6 and 7). The circuit board 7D is also provided with connectors 12d. Flat cables 11 that may be, for example, flexible printed circuits (FPC) or flexible flat cables (FFCs) have connectors 12c configured to be connected to the connectors 12d, respectively. The use of the flat cables 11 as wiring between the light emitters 10 and the circuit board 7D facilitates to reduce the manufacturing process and cost compared to the use of individually independent wiring, twisted wires, or the like.

Components 13 are arranged above and below the circuit board 7D, respectively. To avoid interference between the components 13 and the flat cables 11, the connectors 12d are provided not to upper and lower ends 7a and 7b of the circuit board 7D but to left and right ends 7c and 7d thereof.

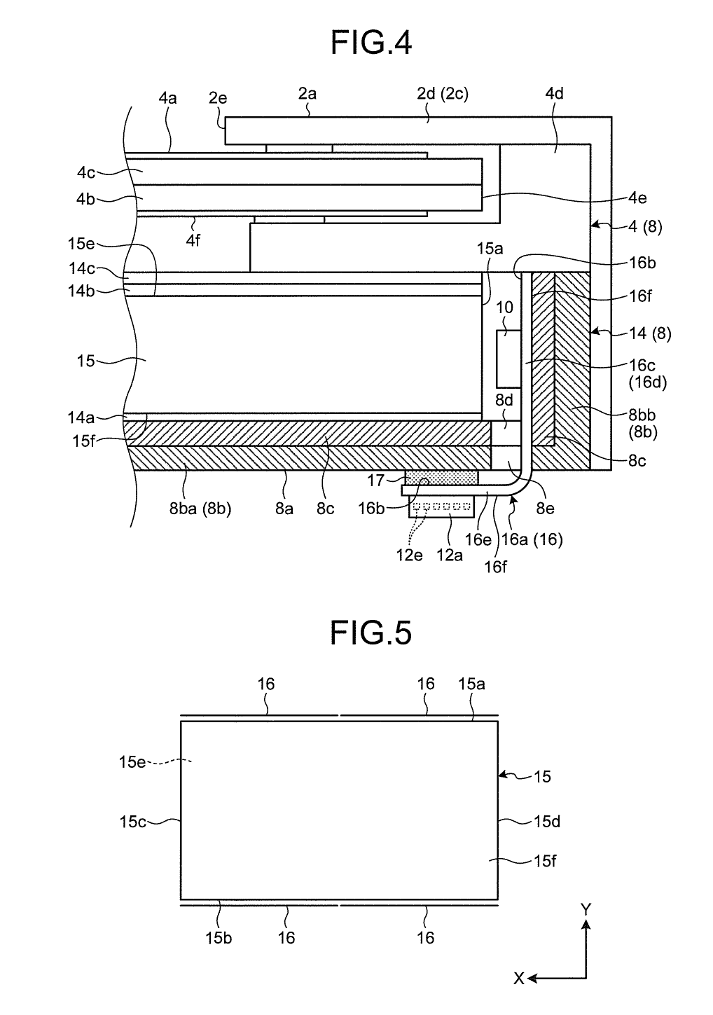

As illustrated in FIG. 4, in the embodiment, the housing 2c comprises the front mask 2d and the back cover 2f (see FIG. 2). The housing 2c houses therein the display unit 8 comprising the display module 4 and a backlight 14. The backlight 14 is assembled into a backlight unit, and then the backlight unit (the backlight 14) is assembled with the display module 4 to form the display unit 8.

The display module 4 comprises a base portion 4b, a panel 4c, a frame 4d, a source circuit board (not illustrated), a source chip-on-film (COF) (not illustrated), a gate COF (not illustrated), and the like.

The backlight 14 comprises the back cover 8b, a radiator 8c, a reflective layer 14a, a light guide 15, a prism layer 14b, a polarization layer 14c, components 16, and the like. All the reflective layer 14a, the light guide 15, the prism layer 14b, and the polarization layer 14c have a flat rectangular shape in the front view. In the embodiment, the back cover 8b has a bottom wall 8ba and a side wall 8bb surrounding the bottom wall 8ba as a rectangular wall portion. The back cover 8b functions as a housing that houses parts of the backlight 14 as a backlight unit. The radiator 8c is arranged along the inside of the side wall 8bb and the bottom wall 8ba. The radiator 8c is made of a material with relatively high radiation performance (for example, metal material such as aluminum alloy).

In the embodiment, among edges 15a to 15d of the light guide 15, the components 16 each having the light emitters 10 (see FIGS. 6 and 7) are located along the edges 15a and 15b facing each other on vertically opposite sides such that they are spaced apart from the edges 15a and 15b, respectively. The edges 15a and 15b extend along edges 4e of the display module 4 that vertically face each other (see FIG. 4). Accordingly, the components 16 also extend along the edges 4e of the display module 4.

As illustrated in FIG. 6, the light emitters 10 provided to each of the components 16 are arranged along a base portion 16c of the component 16. In other words, as can be seen from FIG. 5, the light emitters 10 are arranged, for example, in a line along the edges 15a and 15b. The light emitters 10 are located on the base portion 16c of the component 16 to face the edges 15a and 15b. Accordingly, the light emitted from the light emitters 10 enters the plate-like light guide 15 from the edges 15a and 15b thereof and is emitted from a front surface 15e (see FIG. 4). The reflective layer 14a is located on the side of a back surface 15f. With this, the light emitted from the back surface 15f is reflected on the reflective layer 14a, returns into the light guide 15, and is emitted from the front surface 15e. The light emitted from the front surface 15e passes though the prism layer 14b and the polarization layer 14c and illuminates a back surface 4f of the display module 4 as backlight. The frame 4d is made of a material with relatively high rigidity (for example, metal material, etc.), and functions as the housing of the backlight 14 and the display unit 8 together with the back cover 8b and the frames 9A and 9B.

As illustrated in FIG. 5, in the embodiment, the two components 16 are located along each of the edges 15a and 15b facing each other on vertically opposite sides of the rectangular light guide 15. Namely, there are provided a total of the four components 16. As illustrated in FIGS. 6 and 7, the components 16 each comprise a flexible printed circuit board (FPC) 16a, the light emitters 10, and a connector 12a having a terminal 12e (see FIG. 4). The light emitters 10 and the connector 12a are, for example, soldered onto a surface 16b of the flexible printed circuit board 16a that faces the edge 15c or 15d of the light guide 15. On the flexible printed circuit board 16a are layered an insulating layer and a conductive layer, which forms a conductor pattern (not illustrated). The conductor pattern forms a circuit (not illustrated) in which the terminal 12e of the connector 12a is electrically connected to the light emitters 10. Preferably, the flexible printed circuit board 16a is formed as a multi-layer flexible printed circuit board having conductor patterns that are layered in the thickness direction of the flexible printed circuit board 16a with an insulating layer between them. This reduces the width of the flexible printed circuit board 16a, and thereby prevents the display unit 8 from becoming larger in the normal direction of the display screen 4a because of the width of the flexible printed circuit board 16a. If the flexible printed circuit board 16a as a multi-layer flexible printed circuit board includes a ground layer (not illustrated) as a conductor pattern that forms a ground electrode, it is possible to achieve a radiation effect through the ground layer.

The flexible printed circuit board 16a comprises the fixed-width band-like base portion 16c and a rectangular protruding portion 16e that protrudes from an end portion 16d of the base portion 16c in a direction crossing the base portion 16c (in the embodiment, as an example, in the direction perpendicular to the base portion 16c).

As illustrated in FIG. 4, the base portion 16c is attached to the radiator 8c as a heat conductor by adhesion or screwing as being in close contact with the inner surface of the radiator 8c. With this, it is possible to discharge heat generated by the light emitters 10 through the radiator 8c and suppress the temperature rise.

In the state where the flexible printed circuit board 16a is assembled with the radiator 8c, the protruding portion 16e extends toward the opposite side of the display module 4 (back side, the back surface 8a side). The back cover 8b and the radiator 8c are provided with through holes 8d and 8e as openings corresponding to the protruding portion 16e. The connector 12a having the terminal 12e is provided not to the base portion 16c but to the protruding portion 16e. As a result, the circuit board 7D on the back surface 8a can be relatively easily electrically connected to the flexible printed circuit board 16a via the connector 12a.

If the connector 12a having the terminal 12e is provided to the base portion 16c, the light emitters 10 cannot be arranged where the connector 12a resides. This may result in inconvenience such as a reduction in the illumination range of the light emitters 10 and an increase in the size of the backlight 14 and the housing 2c in the side direction viewed from the front or the back. In this regard, according to the embodiment, the connector 12a having the terminal 12e is provided not to the base portion 16c but to the protruding portion 16e. Thus, such inconvenience can be avoided.

As illustrated in FIG. 4, according to the embodiment, the protruding portion 16e is bent from the side of the edges 15a and 15b of the light guide 15 toward the center (toward the center of the display screen 4a) such that a back surface 16f as the second surface opposite the surface 16b as the first surface is on the outside, i.e., the back surface 16f side is convex while the surface 16b side is concave. Accordingly, the connector 12a provided to the protruding portion 16e is located closer to the center. Thus, compared to the case where the connector 12a is located on the side of the edges 15a and 15b of the light guide 15, it is easier to prevent an increase in the size of the backlight 14 and the housing 2c in the side direction viewed from the front or the back.

As illustrated in FIG. 4, according to the embodiment, the connector 12a is provided not to the surface 16b of the flexible printed circuit board 16a but to the back surface 16f of the bent protruding portion 16e facing above the back surface 8a of the back cover 8b. This facilitates the work of connecting the flat cable 11 to the connector 12a.

According to the embodiment, since the protruding portion 16e is bent, the back surface 8a of the back cover 8b is bonded to the surface 16b as the first surface of the protruding portion 16e via a bonding portion 17. The bonding portion 17 may be, for example, elastic adhesive tape. With this, the protruding portion 16e can be relatively easily fixed to the back cover 8b via the bonding portion 17. Besides, the bonding portion 17 is located on the back side of the connector 12a. This prevents the connector 12a from being loosened and facilitates the work of connecting the flat cable 11 to the connector 12a.

As illustrated in FIG. 6, according to the embodiment, the connector 12a is arranged along the direction in which the protruding portion 16e extends. If it is assumed that the connector 12a is arranged, for example, in parallel to the base portion 16c, the protruding portion 16e may be bent in an L-shape or may have a larger width. If bent, the protruding portion 16e does not readily pass through the through holes 8d and 8e upon assembly. Meanwhile, if the protruding portion 16e is wider, the through holes 8d and 8e are likely to be wider. On this point, in the example of FIG. 6, the connector 12a extends along the direction in which the protruding portion 16e extends (protrudes), which allows the protruding portion 16e to easily pass through the through holes 8d and 8e and the through holes 8d and 8e to be smaller.

As illustrated in FIGS. 3 and 7, according to the embodiment, the flat cable 11 is located between the circuit board 7D and the flexible printed circuit board 16a. Thus, compared to the structure in which the protruding portion 16e extends to the circuit board 7D, assembly is easier.

Preferably, the protruding portion 16e is located at the end of the array of the light emitters 10 or on the center side of the end (in the area A in FIG. 6, at the end of the array in the embodiment). If the protruding portion 16e is located outside the end of the array, it means that the connector 12a is located outside the array. In this case, the connector 12a may increase the size of the backlight 14 and the housing 2c in the side direction viewed from the front or the back.

The above embodiment is susceptible to numerous variations. While, for example, the flexible printed circuit board is described above as being provided with a connector having a terminal, the flexible printed circuit board does not necessarily need the connector. The connector may be provided to the flat cable. If the flat cable is provided with the connector, with the arrangement of the embodiment, the connector of the flat cable does not increase the size of each structure.

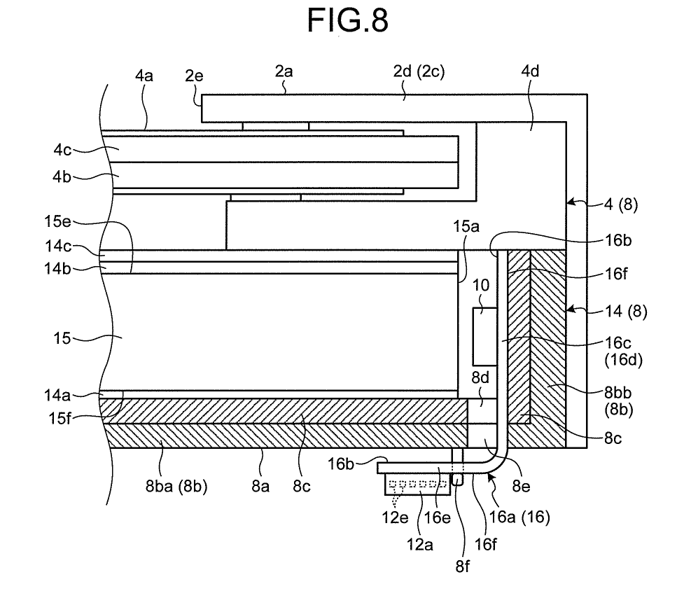

Further, the protruding portion 16e of the flexible printed circuit board 16a need not necessarily be bonded to the back cover 8b as a wall portion via the bonding portion 17. FIG. 8 illustrates a modification of the embodiment. As illustrated in FIG. 8, there may be provided a lock portion 8f that locks the protruding portion 16e on its back using a resilient force of the protruding portion 16e that springs back from the bent shape to the straight one. In this case, the bonding portion 17 is not necessary.

Besides, regarding the video display device, the housing, the display module, the backlight unit, the light guide, the flexible printed circuit board, the light emitter, the terminal, the connector, the component, the base portion, the protruding portion, the wall portion, the circuit board, the flat cable, the bonding portion, and the like, the specifications (structure, shape, size, length, width, thickness, height, number, arrangement, location, material, etc.) can be suitably modified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display device comprising:
a housing;
a display module comprising a display screen, the display module is configured to be at least partly housed in the housing;
a light guide located opposite the display screen with respect to the display module; and
a component comprising
a flexible printed circuit board arranged along an edge of the light guide,
light emitters arranged on the flexible printed circuit board along the edge of the light guide to face the edge, and
a terminal provided to the flexible printed circuit board and configured to be electrically connected to the light emitters, wherein
the flexible printed circuit board comprises
a base portion provided with the light emitters arranged to face the edge, and
a protruding portion extending from the base portion along a direction crossing the base portion toward an opposite side of the display module, the protruding portion comprising the terminal.

2. The video display device of claim 1, further comprising:
a wall portion located opposite the display module with respect to the light guide; and
a circuit board provided on a back surface of the wall portion opposite the display module, the circuit board comprising a circuit configured to be electrically connected to the light emitters to cause the light emitters to emit light.

3. The video display device of claim 2, further comprising a flat cable extending along the back surface of the wall portion and configured to connect the flexible printed circuit board and the circuit board.

4. The video display device of claim 2, further comprising a connector comprising the terminal, wherein
the wall portion is provided with an opening through which the protruding portion passes through, and
the connector is arranged along a direction in which the protruding portion extends.

5. The video display device of claim 2, wherein the terminal is located on a second surface of the flexible printed circuit board opposite a first surface where the light emitters are arranged.

6. The video display device of claim 5, further comprising a bonding portion configured to bond the protruding portion to the wall portion, wherein
the protruding portion is bent such that the second surface is on outside, and
the bonding portion is configured to bond the first surface of the protruding portion to the back surface of the wall portion.

7. The video display device of claim 1, wherein the protruding portion is configured to protrude from the base portion at an end in a longitudinal direction of an array of the light emitters or on a center side of the end in the longitudinal direction.

8. The video display device of claim 1, wherein the flexible printed circuit board is a multi-layer flexible printed circuit board comprising conductor patterns that are layered in a thickness direction.

9. A backlight unit comprising:
a light guide located opposite a display screen of a display module with respect to the display module; and
a component comprising
a flexible printed circuit board arranged along an edge of the light guide,
light emitters arranged on the flexible printed circuit board along the edge of the light guide to face the edge; and
a terminal provided to the flexible printed circuit board and configured to be electrically connected to the light emitters, wherein
the flexible printed circuit board comprises
a base portion provided with the light emitters arranged to face the edge, and
a protruding portion extending from the base portion along a direction crossing the base portion toward an opposite side of the display module, the protruding portion comprising the terminal.
